(19) United States
(12) Patent Application Publication
(10) Pub. No.: US 2008/0002255 A1
(43) Pub. Date: Jan. 3, 2008

(54) Stereoscopic Display Using a Color Parallax Barrier

(76) Inventors: Amon Tavor, Hod Hasharon (IL); Haggai Borkow, Herzlia (IL)

Correspondence Address: Haggai Borkow, 5 Kadima St., Herzlia, 46250, IL

(21) Appl. No.: 11/769,556

(22) Filed: Jun. 27, 2007

Related U.S. Application Data
(60) Provisional application No. 60/806,468, filed on Jul. 2, 2006.
(60) Provisional application No. 60/892,255, filed on Mar. 1, 2007.

(51) Int. Cl. G02B 27/22

(52) U.S. Cl. 359/464

(57) ABSTRACT

Disclosed a method for stereoscopic display using a color parallax barrier consisting of interleaved bands of color filters, allowing left and right eyes to see different color components of the same screen pixels through different color filters, and having left and right images displayed together on screen by combining in same screen pixel color components from left image visible to left eye through color filter and different color components from right image visible to right eye through different color filter. Also disclosed methods for a color parallax barrier that can be activated or inactivated, allowing switching between full-resolution two-dimensional display and three-dimensional stereoscopic display.

### CROSS-REFERENCE TO RELATED APPLICATIONS

This application claims priority from provisional application No. 60/806,468, filed on Jul. 2, 2006, and provisional application No. 60/892,255, filed on Mar. 1, 2007.

### BACKGROUND OF THE INVENTION

This invention pertains to the field of stereoscopic displays without glasses, and specifically to three-dimensional display by projecting different images to both eyes of viewer simultaneously through a parallax barrier.

There are numerous known methods for stereoscopic display, using a single screen to display two images simultaneously, by allocating a portion of the screen pixels (or sub-pixels) for displaying an image to one eye and another portion for the other eye, in an interleaved manner, while those pixels (or sub-pixels) allocated for displaying an image to each eye are hidden from the opposite eye by some form of parallax barrier.

FIG. 1 shows a cross-sectional view illustrating the structure of a conventional parallax barrier. Light from pixels P1 and P2 of display 1 is blocked by opaque bands in parallax barrier 2 to left and right eyes alternatively. When opaque bands in the parallax barrier are used to block light from unwanted pixels to each eye, they become apparent to the viewer as obtrusive black stripes in the image. In addition, when the transparent bands in the barrier are not exactly aligned between the screen pixels and the position of each eye, parts of the wanted pixels become hidden and parts of the unwanted pixels can become visible, causing quality degradation and crosstalk between left and right images.

Even when head tracking is used, and the parallax barrier is moved or the sub-pixels allocated for each eye are shifted to compensate for head movement, image degradation and crosstalk is caused whenever the head moves, due to tracking inaccuracy and latency. Furthermore, when the distance between the head and the display changes, the angle of separation between the eyes also changes, and accurate alignment can not longer be achieved.

FIG. 2 shows a cross-sectional view illustrating the structure of a known sub-pixel parallax barrier. Light from individual sub-pixels of pixels P1 and P2 of liquid crystal display 1 is blocked by narrow opaque bands in parallax barrier 2 to left and right eyes alternatively. While the narrower opaque bands used in the sub-pixel barrier decrease the apparent black stripes, they increase the sensitivity to head movement and misalignment.

Some prior methods use color filters to partially or fully cover the transparent bands between the opaque bands in the parallax barrier, but while those methods may reduce the image crosstalk due to head movement, image degradation still occurs. In addition, these methods do not solve the issue of black stripes, and block more light than conventional parallax barriers.

The purpose of this invention is to enable stereoscopic display without glasses, while minimizing the apparent black stripes caused by opaque bands in the parallax barrier, and allowing maximal head movement without image degradation or crosstalk. It is also the purpose of this invention to enable the stereoscopic display at a low cost, without requiring a specially engineered screen. Another purpose of this invention is to enable switching between two-dimensional and three-dimensional display modes.

### BRIEF SUMMARY OF THE INVENTION

According to this invention, improved stereoscopic display is achieved using a color parallax barrier consisting of interleaved bands of color filters, allowing left and right eyes to see different color components of the same screen pixels through different color filters, and having left and right images displayed together on screen by combining in same screen pixel color components from left image visible to left eye through color filter and different color components from right image visible to right eye through different color filter.

Since the color parallax barrier contains no opaque bands, the black stripes seen with conventional parallax barriers are reduced or eliminated. Since the human eye is less sensitive to color resolution than to light resolution, and since the color parallax barrier enables each eye to see light from each pixel on the screen, the perceived quality achieved with in this method is better than prior methods.

When the viewer head moves, the color filters block color components from adjacent pixels from reaching the wrong eye, thus allowing more head movement than prior methods, without image degradation or crosstalk. The color parallax barrier can be used with fixed viewing positions, as well as with head tracking, and reduces the requisite speed and accuracy of the head tracking system.

This method does not require any modifications in the display device, and can work with conventional display devices, such as standard computer LCD monitors. Moreover, the color parallax barrier can be manufactured at a low cost, for example using color inks printed on a transparent sheet of plastic.

This invention further includes methods for a color parallax barrier that can be activated or inactivated, allowing switching between full-resolution two-dimensional display and three-dimensional stereoscopic display. One method incorporates closed liquid channels, embedded in a transparent sheet of plastic. The liquid channels are filled with ink to activate the color parallax barrier for stereoscopic viewing. When the liquid channels are emptied the barrier becomes transparent, allowing normal viewing.

Another method for a switchable color parallax barrier included in this invention incorporates color dependent light polarization elements, and a light polarizing filter. Wavelength dependent light polarizers or wavelength dependent wave retarders are used to selectively polarize light of different colors, and the polarizing filter blocks the light based on polarization. Switching between stereoscopic and normal display is done by deactivating either the color dependent light polarization elements or the light polarizing filter.

### BRIEF DESCRIPTION OF THE DRAWINGS

FIG. 1 shows a cross-sectional view illustrating the structure of a conventional parallax barrier.

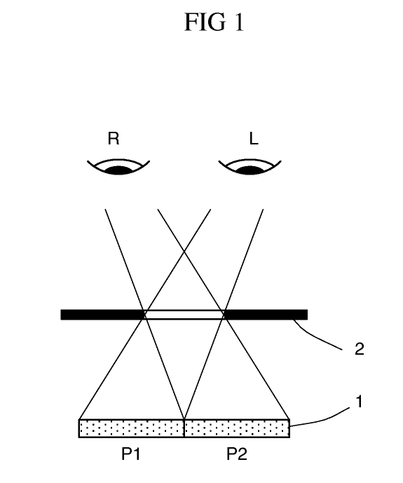

FIG. 2 shows a cross-sectional view illustrating the structure of a known sub-pixel parallax barrier.

FIG. 3 shows a cross-sectional view illustrating the structure of a color parallax barrier.

FIG. 4 shows a cross-sectional view illustrating the structure of a color parallax barrier using subtractive colors.

FIG. 5 shows a cross-sectional view illustrating the structure of a color parallax barrier using one additive (primary) color and one subtractive (complementary) color.

FIG. 6 shows a cross-sectional view illustrating the use of a color parallax barrier with a display having sub-pixel color display elements.

FIGS. 7A and 7B show cross-sectional views illustrating the function of the color parallax barrier with lateral head movement.

FIGS. 8A and 8B show cross-sectional views illustrating the function of the color parallax barrier with forward and backward head movement.

FIG. 9 shows a cross-sectional view illustrating the use of a color parallax barrier using subtractive colors with a display having sub-pixel color display elements.

FIG. 10 shows a cross-sectional view illustrating the structure of a color parallax barrier using additive (primary) colors and subtractive (complementary) colors.

FIGS. 11A and 11B show cross-sectional views illustrating the function of a color parallax barrier containing additive and subtractive color filters with head movement.

FIG. 12 shows a cross-sectional view illustrating the structure of a color parallax barrier used with adaptive sub-pixel allocation.

FIG. 13 shows a cross-sectional view illustrating the structure of a color parallax barrier with lenticular shape.

FIG. 14 shows a front view illustrating the structure and function of a diagonal color parallax barrier.

FIGS. 15A and 15B show cross-sectional views illustrating the structure and function of a switchable parallax barrier with liquid channels.

FIG. 16 shows a cross-sectional view illustrating the structure of a switchable color parallax barrier using liquid channels.

FIGS. 17A and 17B show cross-sectional views illustrating the structure of a switchable color parallax barrier using layers of liquid channels.

FIGS. 18A and 18B show cross-sectional views illustrating the structure and function of a switchable color parallax barrier containing wavelength dependent light polarizers and a liquid crystal polarizing filter.

FIGS. 19A and 19B show cross-sectional views illustrating the structure and function of a switchable color parallax barrier containing a polarizing filter, wavelength dependent wave retarders and a liquid crystal polarizing filter.

FIGS. 20A and 20B show cross-sectional views illustrating the structure and function of a switchable color parallax barrier containing wavelength dependent wave retarders and a liquid crystal polarizing filter.

FIGS. 21A and 21B show cross-sectional views illustrating the structure and function of a switchable color parallax barrier containing wavelength dependent wave retarders and a liquid crystal polarizing filter perpendicular to the polarization of a liquid crystal display device.

FIGS. 22A and 22B show cross-sectional views illustrating the structure and function of a switchable color parallax barrier containing two layers of wavelength dependent wave retarders and a polarizing filter.

FIGS. 23A and 23B show cross-sectional views illustrating the structure and function of a switchable color parallax barrier containing two phase-shifted layers of wavelength dependent wave retarders and a polarizing filter.

FIGS. 24A and 24B show cross-sectional views illustrating the structure and function of a switchable color parallax barrier containing two phase-shifted layers of spaced apart wavelength dependent wave retarders and a polarizing filter.

### DETAILED DESCRIPTION OF THE INVENTION

For the purpose of enabling stereoscopic display without glasses, a color parallax barrier is used in tandem with a conventional color display device. The display device having a plurality of display elements (pixels) capable of emitting or transmitting light, where the intensity of each color component of the light can be controlled individually for each pixel. The color parallax barrier having a plurality of interleaved bands of color filters, with no opaque bands or transparent bands, so different color filters transmit different color components of the light emitted by the display device.

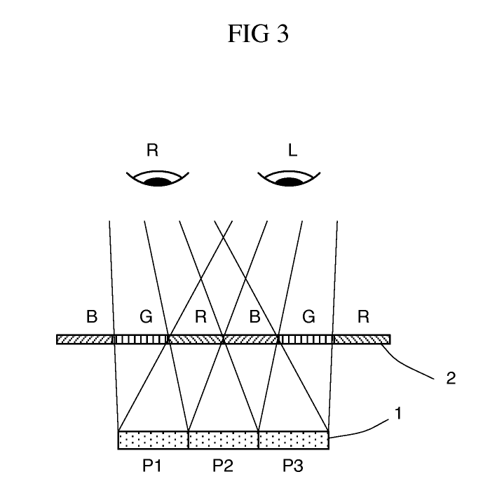

FIG. 3 shows a cross-sectional view illustrating the structure of a color parallax barrier. Each pixel in display 1 is capable of emitting light of red, green and blue components. Color parallax barrier 2 contains interleaved bands of red, green and blue color filters. Each pixel is seen by left and right eyes through different color filters. In the shown example, P1 is seen by right eye through green filter G, and by left eye through red filter R. These colors alternate in each consecutive pixel, and the pattern repeats across the display.

The light intensities of the color components in each display pixel are set combining color information from left eye image and right eye image, according to the color components visible to each eye through the color filters. In the example shown in FIG. 3, pixel P1 contains green light intensity corresponding to right image data, and red light intensity corresponding to left image data.

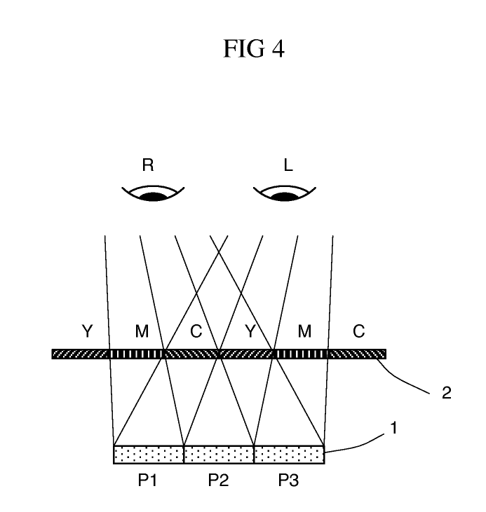

FIG. 4 shows a cross-sectional view illustrating the structure of a color parallax barrier using subtractive colors. Color parallax barrier 2 uses filter colors complementary to the color components of display 1. Cyan filter C blocks the red component, magenta filter M blocks the green component, and yellow filter Y blocks the blue component. Each display pixel displays for each eye the color component that is blocked from the opposite eye by the corresponding color filter. In the example shown, pixel P1 contains red light intensity corresponding to right image data, and green light intensity corresponding to left image data.

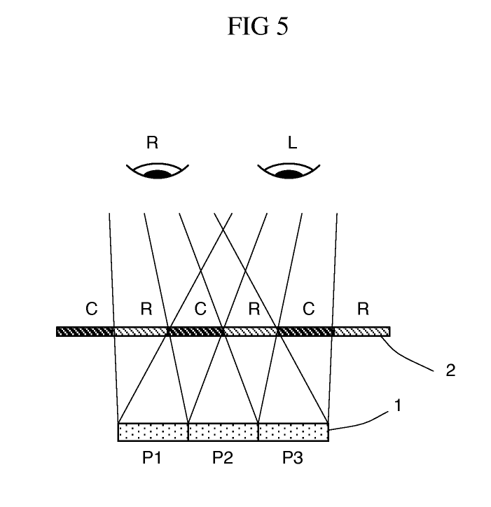

FIG. 5 shows a cross-sectional view illustrating the structure of a color parallax barrier using one additive (primary) color and one subtractive (complementary) color. In the shown example, color parallax barrier 2 contains red filters for transmitting red component from display 1, and cyan filters for transmitting all components but red. In this example display pixel P1 contains red component from right image data, and green and blue components from left image data. This enables using all the color components in each pixel, thus improving the resolution and light yield of the display.

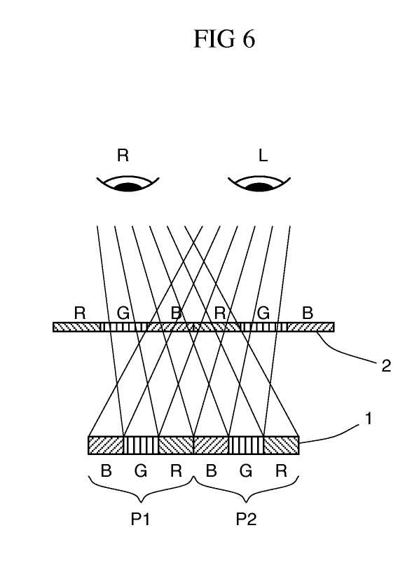

FIG. 6 shows a cross-sectional view illustrating the use of a color parallax barrier with a display having sub-pixel color display elements. Common liquid crystal display 1 uses color sub-pixel display elements for displaying all the primary colors in each pixel. Color parallax barrier 2 uses filter colors corresponding to the display sub-pixel colors, having the width of each filter approximate the width of two sub-pixels, and the order of the color filters in reverse to the spatial order of the display sub-pixels.

The color parallax barrier shown in FIG. 6 transmits to each eye light from every other sub-pixel display element of the display. In the shown example, the right eye sees the green component of pixel P1, while the left eye sees the green component of pixel P2. This order is reversed with each color component, and repeated across the display.

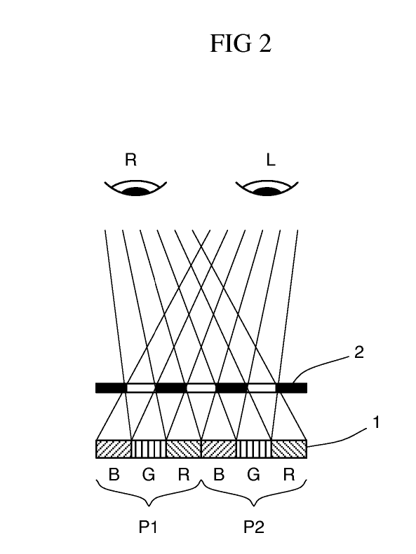

As seen in FIG. 6, the color parallax barrier yields the same high resolution as the formerly known sub-pixel barrier method shown in FIG. 2, using opaque and transparent bands. However, the color parallax barrier does not bear the sensitivity to misalignment or head movement which causes image degradation and crosstalk of known methods.

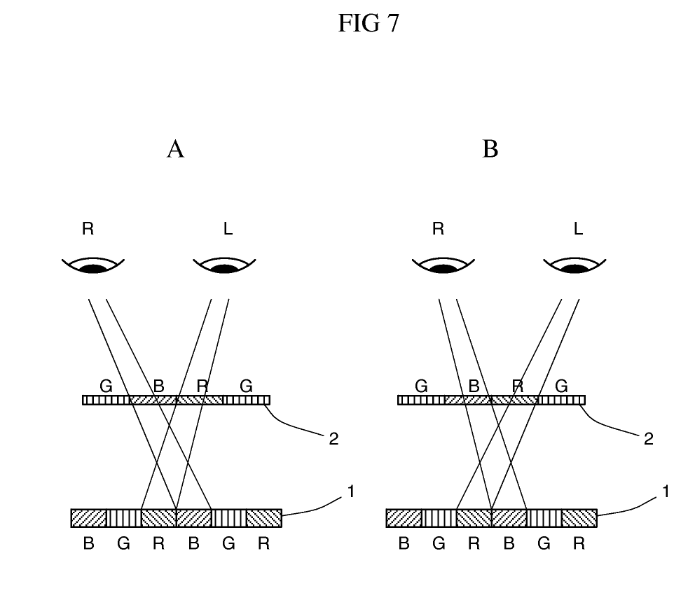

FIGS. 7A and 7B show cross-sectional views illustrating the function of the color parallax barrier with lateral head movement. While the position of display 1 and color parallax barrier 2 remain static, the head moves horizontally from position A to position B, and stereoscopic vision is maintained with no image degradation or crosstalk.

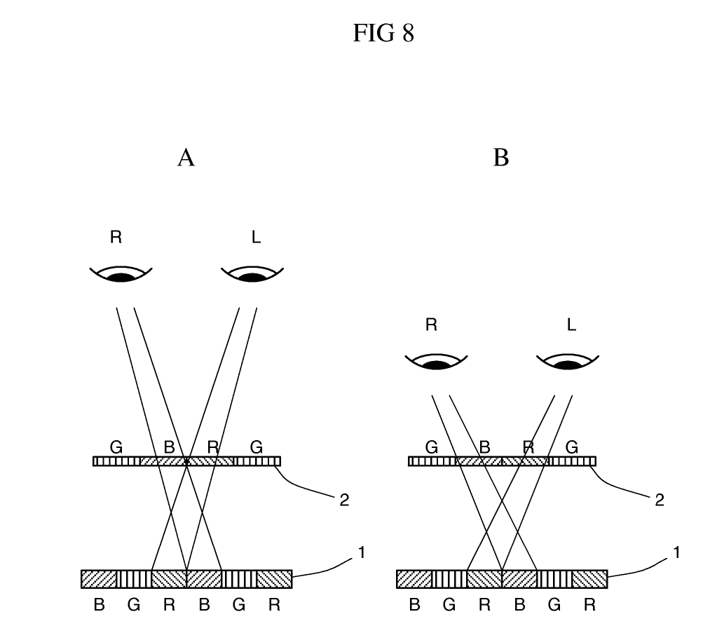

FIGS. 8A and 8B show cross-sectional views illustrating the function of the color parallax barrier with forward and backward head movement. While the position of display 1 and color parallax barrier 2 remain static, the head distance changes from position A to position B, and stereoscopic vision is maintained with no image degradation or crosstalk.

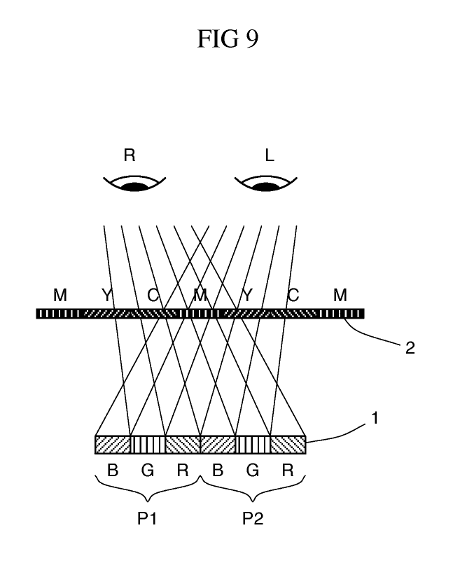

FIG. 9 shows a cross-sectional view illustrating the use of a color parallax barrier using subtractive colors with a display having sub-pixel color display elements. In this alternative configuration, the color parallax barrier 2 uses filter colors complementary to the sub-pixel colors of display 1. Each of the subtractive filter colors blocks one of the color components of each pixel from each eye, in an alternating pattern across the display. In the shown example, green sub-pixel G of pixel P1 can be seen by the right eye through either the cyan filter C or the yellow filter Y, but it is blocked from the left eye by magenta filter M.

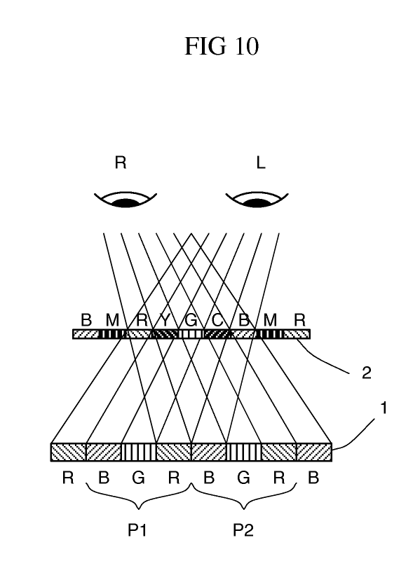

FIG. 10 shows a cross-sectional view illustrating the structure of a color parallax barrier using additive (primary) colors and subtractive (complementary) colors. Color parallax barrier 2 contains additive filter colors red, green and blue, and subtractive filter colors cyan, magenta and yellow. The width of each filter approximates the width of one sub-pixel of display 1.

As shown in FIG. 10, the order of the additive color filters is in reverse to the order of the corresponding sub-pixels, and the subtractive color filters are interleaved between the additive color filters which transmit the same color components. For example, the yellow filter, which transmits red and green, is placed between the red and the green filters. In the shown example, red sub-pixel R of pixel P1 is seen by right eye through red color filter R, and blocked from the left eye by cyan color filter C.

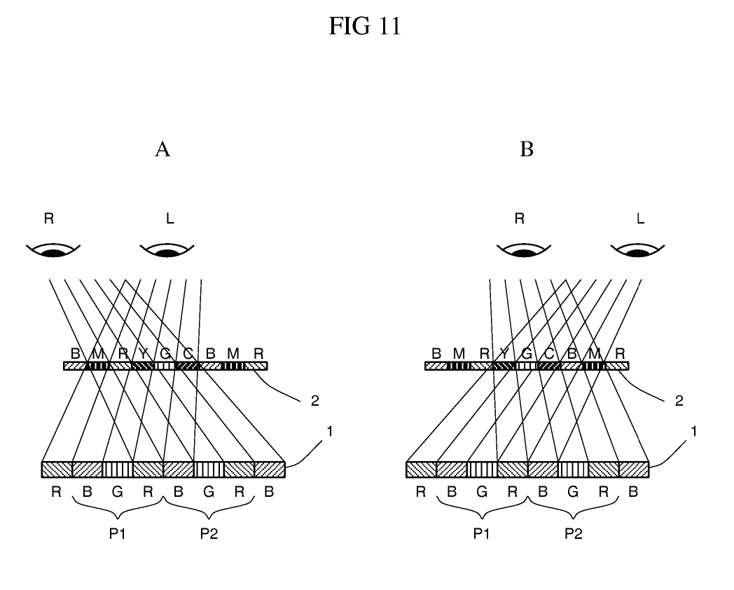

FIGS. 11A and 11B show cross-sectional views illustrating the function of a color parallax barrier containing additive and subtractive color filters with head movement. While the position of display 1 and color parallax barrier 2 remain static, the head moves horizontally from position A to position B, and stereoscopic vision is maintained with no image degradation or crosstalk.

In the example shown in FIG. 11, when the head is in position A, red sub-pixel R of pixel P1 is seen by right eye through magenta color filter M, and blocked from the left eye by green color filter G. When the head is in position B, the red sub-pixel R of pixel P1 is seen by right eye through yellow color filter Y, and blocked from the left eye by blue color filter B. This arrangement enables twice the head movement of the former additive or subtractive color filter arrangements.

The head movement enabled by the color parallax barrier is beneficial for stereoscopic display with fixed viewing positions. Furthermore the color parallax barrier is beneficial with a head tracking system, where the barrier is moved in correlation with the head movement, relieving the tracking system speed and accuracy requirements. A known, cheaper alternative to moving the barrier is adaptive sub-pixel allocation, where the barrier remains static, and display sub-pixels are dynamically allocated for displaying left and right images, in correlation with the head position.

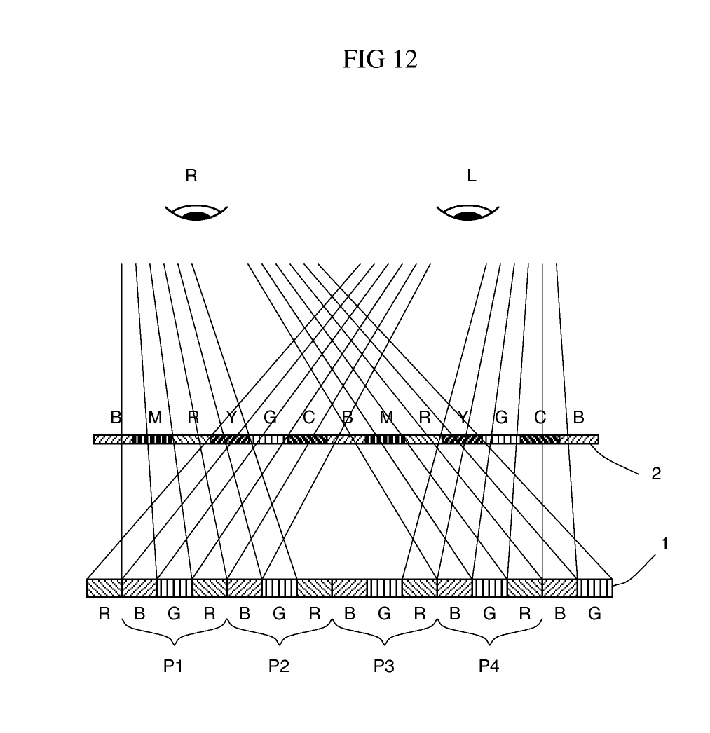

FIG. 12 shows a cross-sectional view illustrating the structure of a color parallax barrier used with adaptive sub-pixel allocation. Color parallax barrier 2 contains additive and subtractive color filters as explained above. In the shown example, the width of the cycle of color filters approximates the width of three pixels of display 1.

Once per cycle of color filters, sub-pixels are turned off to prevent image crosstalk, in correlation with the head position. In the example shown in FIG. 12, sub-pixels P2:R, P3:B and P3:G are turned off. In this method stereoscopic display is maintained with unlimited lateral head movement, as well as substantial forward and backward movement.

The resolution of the color parallax barrier is not directly linked to the resolution of the display. Hence, a color parallax barrier can be adapted algorithmically to displays of various resolutions, merely by turning off display elements in a cycle matching the width of the cycle of color filters in the color parallax barrier.

The color parallax barrier can have a lenticular shape, or be affixed to a transparent lenticular surface. The magnifying effect of the lenses reduces the visible gaps in the images caused by display elements that are turned off.

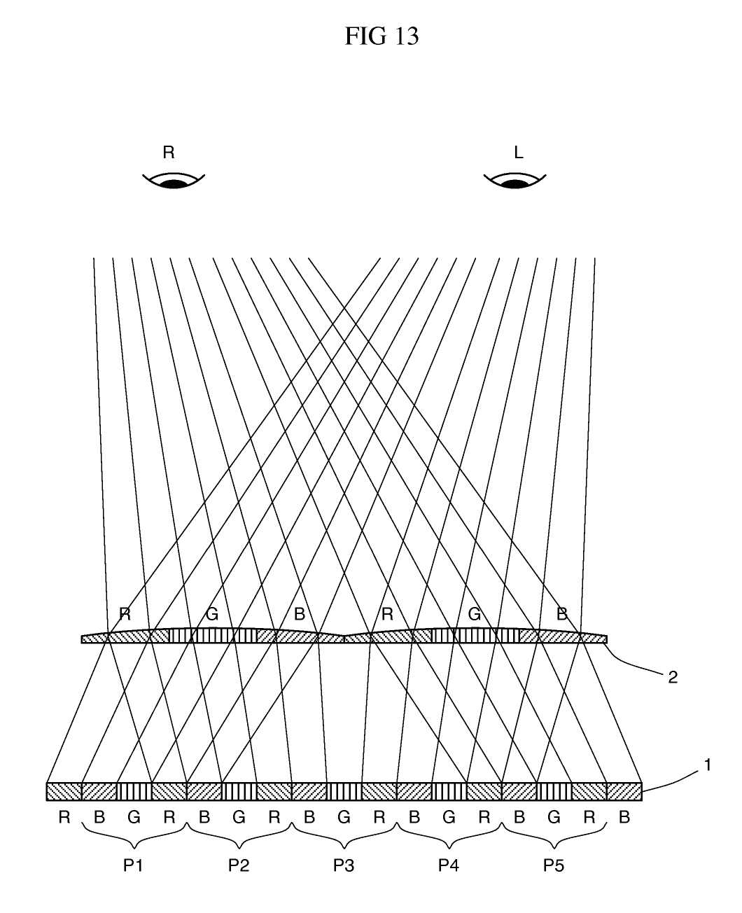

FIG. 13 shows a cross-sectional view illustrating the structure of a color parallax barrier with lenticular shape. In the shown example, color parallax barrier 2 forms cylindrical lenses, where each lens matches one cycle of color filters, approximating the width of three pixels of display 1. As this drawing shows, the areas of unused sub-pixels are not seen through the lenses. For example, sub-pixels P2:G through P3:G are not seen by the left eye, and would have created a noticeable black stripe if the shape of barrier had not been lenticular.

The bands of color filters in the color parallax barrier can be arranged at an angle relative to the display pixels. This arrangement produces a delta pattern of sub-pixels visible through the diagonal color filter bands. This method reduces the vertical lines that may be noticed when a vertical parallax barrier is used.

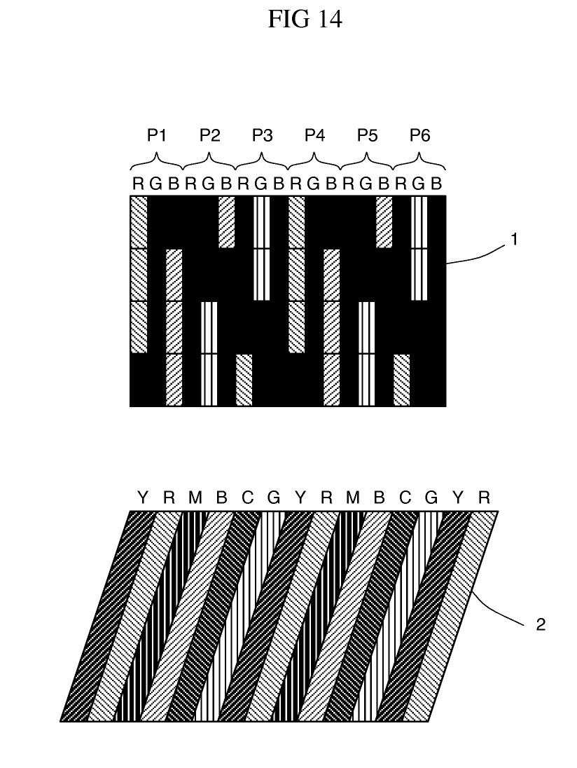

FIG. 14 shows a front view illustrating the structure and function of a diagonal color parallax barrier. Diagonal color parallax barrier 2 is placed in front of display 1. The diagram of the display shows only the sub-pixels visible to one eye through the diagonal color parallax barrier, while other sub-pixels appear black. In the example shown, the bands have a slope of 3:1, causing the visible sub-pixels of each color to be shifted horizontally every 3 pixels.

According to this invention, a color parallax barrier can use numerous arrangements of color filters. It can have various resolutions, and work with various types of color display devices. The surface of the barrier can be flat or lenticular, and the color filter bands can be vertical or diagonal. It can be used with head tracking, or with fixed viewing positions.

In a preferred embodiment, the color parallax barrier is attached to a conventional liquid crystal display (LCD), and uses both additive (primary) colors and subtractive (complementary) colors, in reverse order to the LCD sub-pixels. The preferred width of the cycle of color filters approximates two pixels for fixed viewing positions, or three pixels for dynamic pixel allocation with head tracking, where diagonal filter bands may also be employed.

When a parallax barrier is fixed to a display device, full-resolution two-dimensional display is not possible without dismantling the barrier, unless a method is provided for switching the barrier off.

For the purpose of enabling switching between two-dimensional display and three-dimensional display, a parallax barrier is constructed of transparent material, with a plurality of embedded liquid channels. The channels are connected to a liquid ink reservoir, which is placed outside the visible area of the display. A pump attached to the reservoir drives ink into or out of the liquid channels.

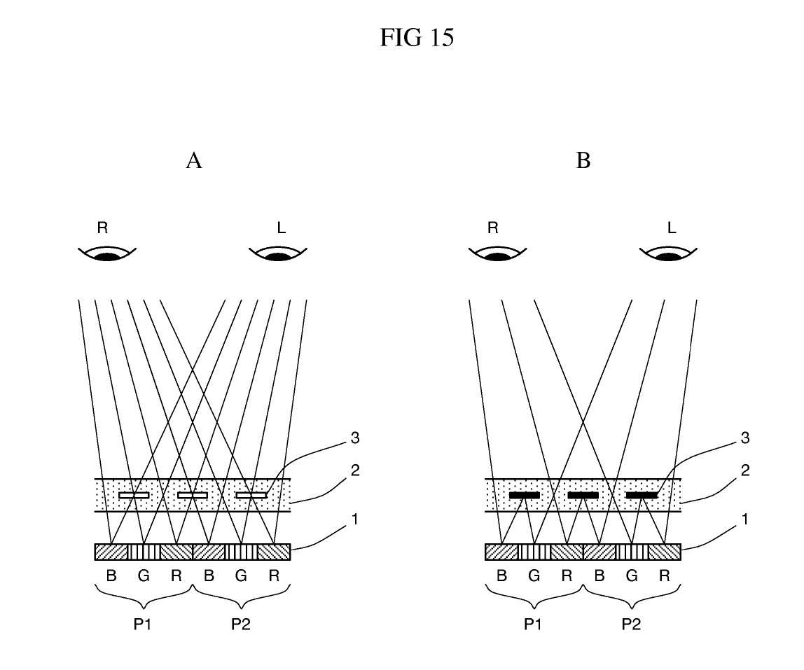

FIGS. 15A and 15B show cross-sectional views illustrating the structure and function of a switchable parallax barrier using liquid channels. Transparent barrier 2, with embedded liquid channels 3, is positioned in front of display device 1. In state A the channels are empty, and full-resolution two-dimensional display is enabled. In state B the channels are filled with ink, blocking the light path from alternating display elements to left and right eyes. In the shown example, sub-pixel P1:R is only visible to the right eye, and sub-pixel P2:B is only visible to the left eye.

The example shown in FIG. 15 pertains to a black parallax barrier, therefore the channels in state B are filled with black ink. For a switchable color parallax barrier, color inks are used instead of black ink. Each group of liquid channels assigned for one color are connected to one liquid ink reservoir and pump.

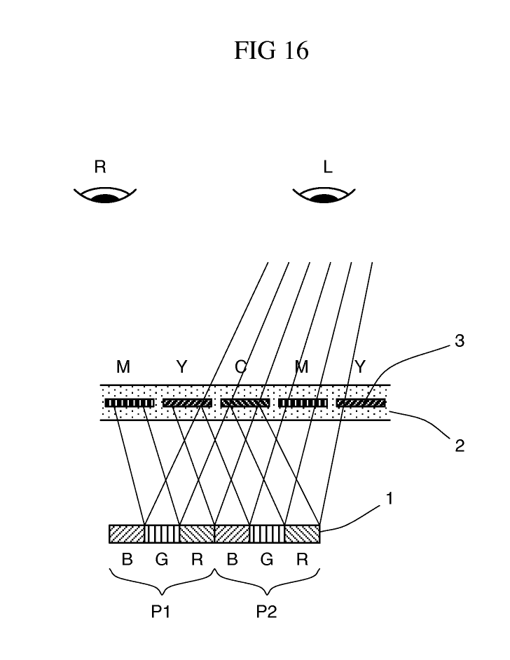

FIG. 16 shows a cross-sectional view illustrating the structure of a switchable color parallax barrier using liquid channels. Transparent barrier 2, with embedded liquid channels 3, is positioned in front of display device 1. The liquid channels are filled in sequence with cyan ink C, magenta ink M and yellow ink Y. In the shown example, green light from sub-pixel P1:G is blocked from right eye by liquid channel containing magenta ink. For convenience, the drawing shows only the paths of light from sub-pixels containing left image data.

The barrier structure illustrated in FIG. 16 enables only limited head movement, since the gaps between the liquid channels embedded in the barrier can transmit all colors of light. To avoid the gaps, the liquid channels can be arranged in layers, so the channels in each layer completely cover the gap between the channels in the other layer, possibly with some overlap.

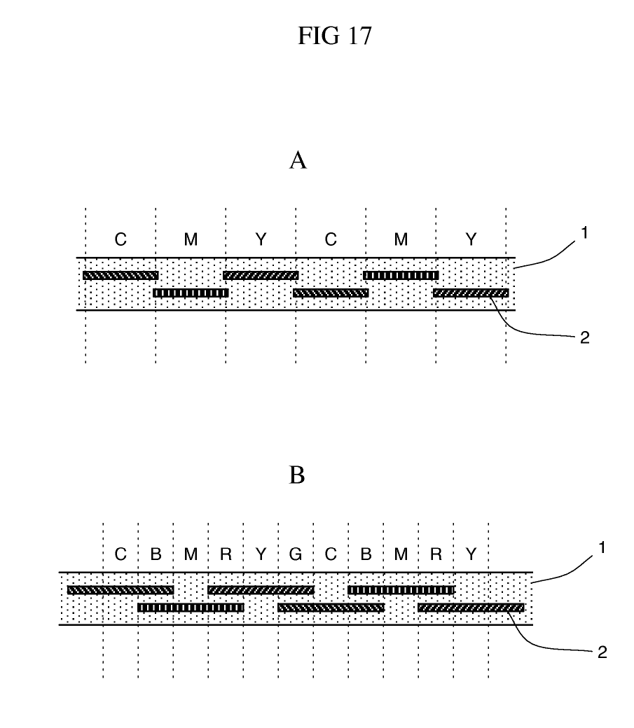

FIGS. 17A and 17B show cross-sectional views illustrating the structure of a switchable color parallax barrier using layers of liquid channels. Transparent barrier 1, with embedded liquid channels 2. In configuration A, a small overlap between the channels blocks unwanted light from escaping between the channels at an angle. In configuration B, a larger overlap generates regions where light is blocked by two tandem ink channels.

As shown in configuration B of FIG. 17, each combination of two subtractive color filters generates an additive color filter. For example, cyan blocks red light and magenta blocks green light, hence their combination transmits only blue light. Thus the preferred configuration containing additive and subtractive color filters is achieved, allowing maximal head movement without image degradation or crosstalk. Moreover, this configuration of six filter colors is achieved using just three groups of channels and ink reservoirs.

Color filters can be generated by polarizing light of selected wavelengths, and using a polarizing filter to block or transmit colors of light based on their polarization. When a color parallax barrier is constructed of color filters using this principle, the color parallax barrier can be switched off for two-dimensional viewing by disabling either the polarizing filter or the wavelength dependent polarization.

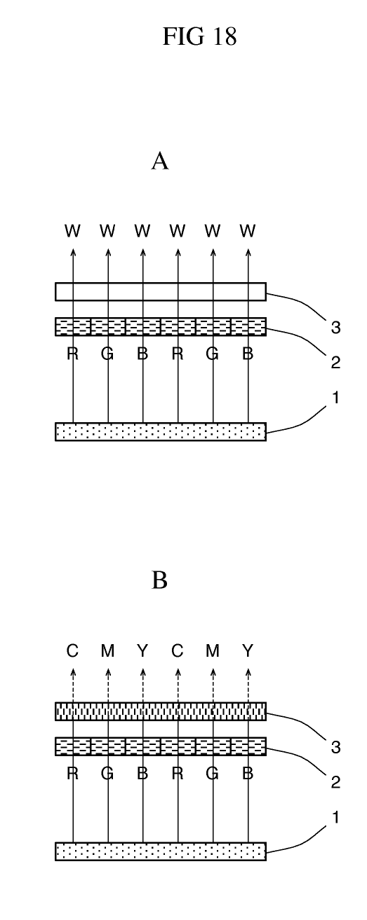

FIGS. 18A and 18B show cross-sectional views illustrating the structure and function of a switchable color parallax barrier containing wavelength dependent light polarizers and a liquid crystal polarizing filter. Bands of wavelength dependent light polarizers 2 and liquid crystal polarizing filter 3 are placed in front of display device 1. When active, the polarization axis of the liquid crystal polarizing filter is perpendicular to the polarization axis of the wavelength dependent light polarizers.

As shown in FIG. 18, in state A the liquid crystal polarizing filter is inactive, and all colors of light are transmitted regardless of their polarization, thus full-resolution two-dimensional viewing is enabled. In state B the liquid crystal polarizing filter is electronically activated, blocking the wavelengths of light that have been polarized by the bands of wavelength dependent light polarizers, creating bands of color filters with alternating colors, thus enabling three-dimensional viewing. For example, wavelength dependent light polarizer R polarizes red light, which is then blocked by the liquid crystal polarizing filter, creating a cyan filter.

The bands of wavelength dependent light polarizers can be substituted with static light polarizer sheet and bands of wavelength dependent wave retarders. The polarizer sheet polarizes all light from the display device, and then the polarization of selected light colors is changed by the bands of wave retarders. Half-wave plates can act as wave retarders and rotate the axis of polarization of selected light frequencies by 90 degrees, depending on the thickness of each wave retarders band.

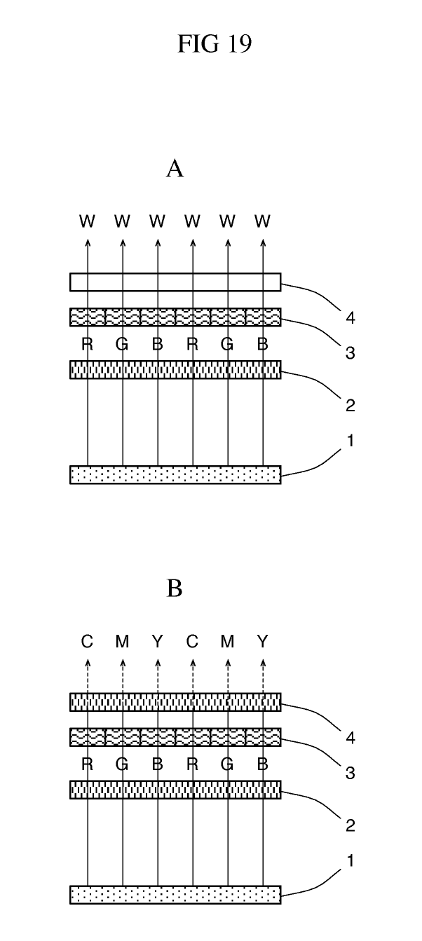

FIGS. 19A and 19B show cross-sectional views illustrating the structure and function of a switchable color parallax barrier containing a polarizing filter, wavelength dependent wave retarders and a liquid crystal polarizing filter. Light polarizer sheet 2, bands of wavelength dependent wave retarders 3 and liquid crystal polarizing filter 4 are placed in front of display device 1. When active, the polarization axis of the liquid crystal polarizing filter is parallel to the polarization axis of the static polarizer sheet.

As shown in FIG. 19, in state A the liquid crystal polarizing filter is inactive, and all colors of light are transmitted regardless of their polarization. In state B the liquid crystal polarizing filter is electronically activated, blocking the wavelengths of light that had their polarization axis changed by the bands of wavelength dependent wave retarders. For example, wavelength dependent wave retarder R rotates the polarization axis of red light by 90 degrees, and the red light is then blocked by the liquid crystal polarizing filter, creating a cyan filter.

The method shown in FIGS. 18 and 19, and explained above, pertains to display devices emitting unpolarized light, such as plasma display or surface emission display. When liquid crystal display is used, the light emitted from the display is already polarized, hence the sheet of polarizing filter can be omitted.

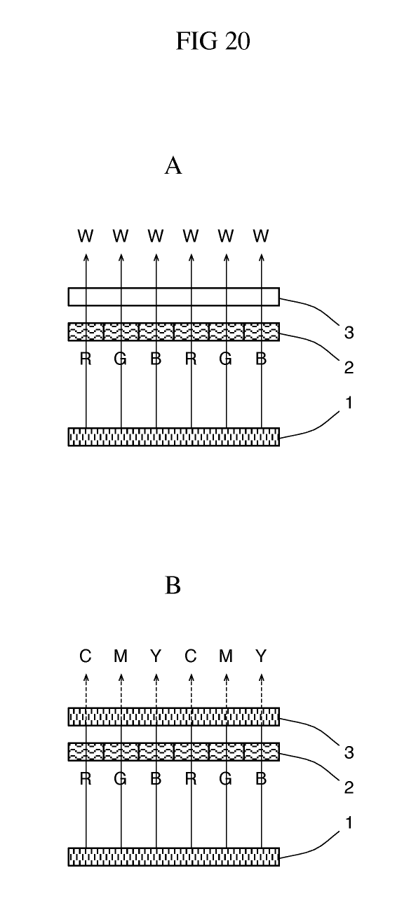

FIGS. 20A and 20B show cross-sectional views illustrating the structure and function of a switchable color parallax barrier containing wavelength dependent wave retarders and a liquid crystal polarizing filter. Bands of wavelength dependent wave retarders 2 and liquid crystal polarizing filter 3 are placed in front of liquid crystal display 1. When active, the polarization axis of the liquid crystal polarizing filter is parallel to the polarization axis of light emitted from the liquid crystal display.

As shown in FIG. 20, in state A the liquid crystal polarizing filter is inactive, and all colors of light are transmitted regardless of their polarization. In state B the liquid crystal polarizing filter is electronically activated, blocking the wavelengths of light that had their polarization axis changed by the bands of wavelength dependent wave retarders.

Color filters that transmit additive colors can be created using a liquid crystal polarizing filter that, when active, has a polarization axis perpendicular to the polarization axis of light emitted from the liquid crystal display.

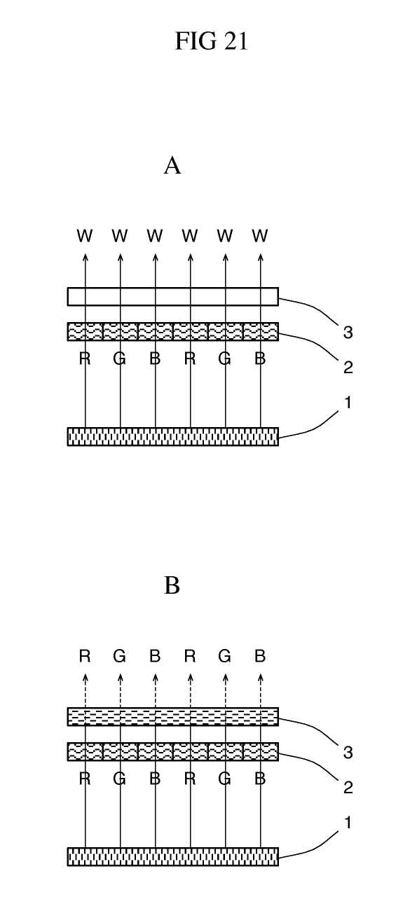

FIGS. 21A and 21B show cross-sectional views illustrating the structure and function of a switchable color parallax barrier containing wavelength dependent wave retarders and a liquid crystal polarizing filter perpendicular to the polarization of a liquid crystal display device. Bands of wavelength dependent wave retarders 2 and liquid crystal polarizing filter 3 are placed in front of liquid crystal display 1. For example, as shown in active state B, wavelength dependent wave retarder R rotates the polarization axis of red light by 90 degrees, and all light frequencies but the red light are then blocked by the liquid crystal polarizing filter, creating a red filter.

The liquid crystal polarizing filter can be substituted with a static light polarizer sheet, if two layers of wavelength dependent wave retarders are used, and switching is done by shifting the layers of wave retarders.

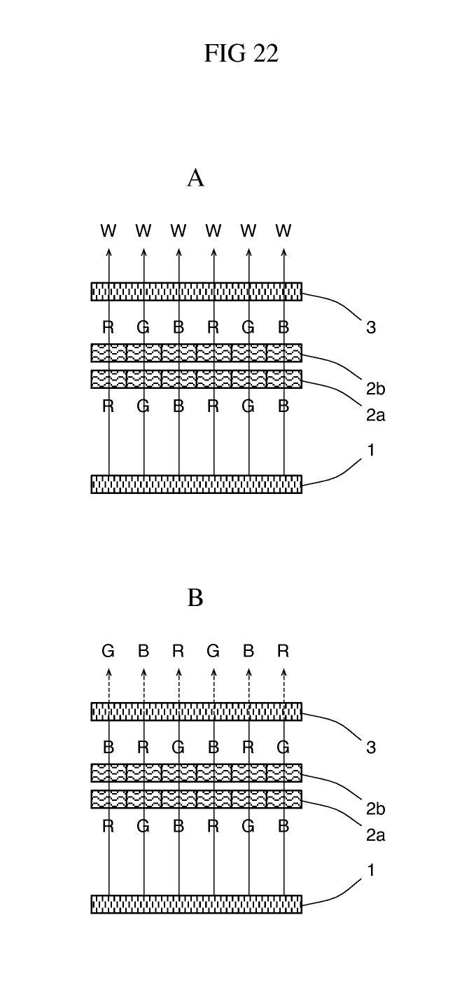

FIGS. 22A and 22B show cross-sectional views illustrating the structure and function of a switchable color parallax barrier containing two layers of wavelength dependent wave retarders and a polarizing filter. Layers of wavelength dependent wave retarders 2a and 2b, and static light polarizer sheet 3 are placed in front of liquid crystal display 1. The polarization axis of the polarizing filter is parallel to the polarization axis of light emitted from the liquid crystal display.

As shown in FIG. 22, in state A the two layers of wave retarders are positioned in sync, and are canceling each other out, since the polarization axis of each color light is rotated by 90 degrees twice, therefore all light is transmitted through the polarizing filter. In state B the layers of wave retarders are shifted out of sync, creating bands of color filters. For example, as shown in the drawing, the polarization axis of red and blue light passing through red wave retarder R and blue wave retarder B is rotated, therefore only the remaining green light passes through the polarizing filter.

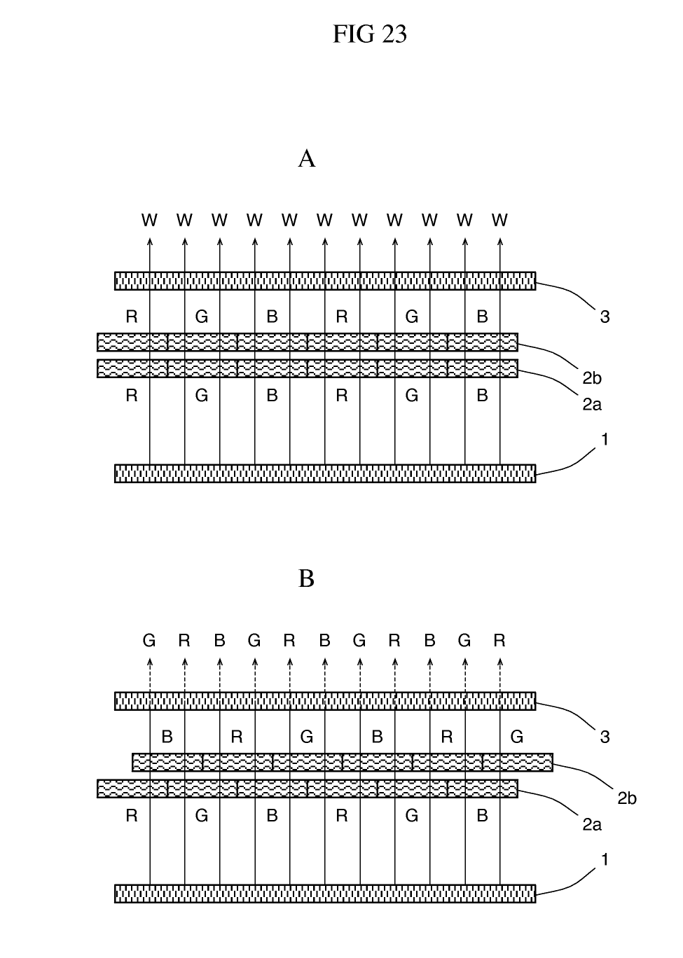

FIGS. 23A and 23B show cross-sectional views illustrating the structure and function of a switchable color parallax barrier containing two phase-shifted layers of wavelength dependent wave retarders and a polarizing filter. Layers of wavelength dependent wave retarders 2a and 2b, and static light polarizer sheet 3 are placed in front of liquid crystal display 1. In the shown example, the width of each band of wavelength dependent wave retarder equals twice the requisite width of the color filters.

As shown in FIG. 23, in state A the two layers of wave retarders are positioned in sync, and are canceling each other out. In state B the layers of wave retarders are in 180 degrees phase shift, creating two bands of color filters per wave retarder band. For example, as shown in the drawing, the section of overlap between red wave retarder R and blue wave retarder B creates a green color filter band. This arrangements uses wider bands of wave retarders, and mitigates shifting accuracy.

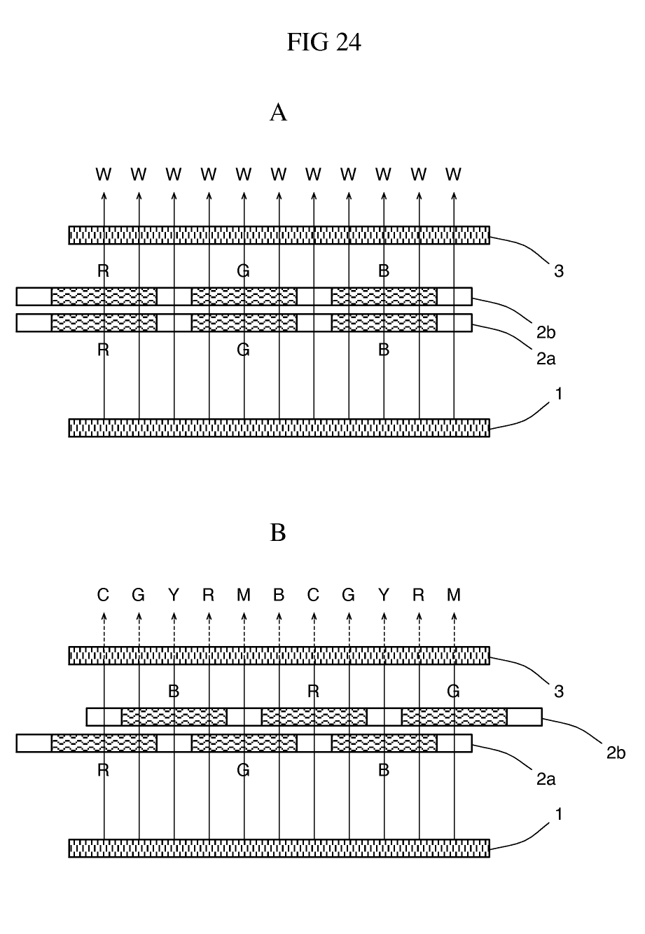

FIGS. 24A and 24B show cross-sectional views illustrating the structure and function of a switchable color parallax barrier containing two phase-shifted layers of spaced apart wavelength dependent wave retarders and a polarizing filter. Layers of wavelength dependent wave retarders 2a and 2b, and static light polarizer sheet 3 are placed in front of liquid crystal display 1. In the shown example, the width of each band of wavelength dependent wave retarder equals three times the requisite width of the color filters, and the gap between neighboring wave retarder bands equals the width of one color filter.

As shown in FIG. 24, in state A the two layers of wave retarders are positioned in sync, and are canceling each other out. In state B the layers of wave retarders are in 180 degrees phase shift, creating a color filters per overlap section or gap section. For example, as shown in the drawing, the section of overlap between red wave retarder R and blue wave retarder B creates a green color filter, and the section of red wave retarder R that is not overlapped creates a cyan color filter.

As shown in state B of FIG. 24, the disposition of spaced apart wavelength dependent wave retarder bands generates color filter bands in the preferred arrangement, containing both additive and subtractive color filters. Thus allowing stereoscopic display with maximal head movement without image degradation or crosstalk, using a static polarizer and two layers of wave retarders, while shifting one of the layers to achieve switching between two-dimensional and three-dimensional display.

1. Stereoscopic display method using a color parallax barrier consisting of interleaved bands of color filters, allowing left and right eyes to see different color components of the same screen pixels through different color filters, and having left and right images displayed together on screen by combining in same screen pixel color components from left image visible to left eye through color filter and different color components from right image visible to right eye through different color filter.

2. The stereoscopic display method of claim 1, where the filter colors match the color components of the screen, so that each filter transmits one of the color components of the screen.

3. The stereoscopic display method of claim 1, where the filter colors match the complementary colors of the color components of the screen (subtractive colors), so that each filter transmits all but one of the color components of the screen.

4. The stereoscopic display method of claim 1, where some filter colors match the color components of the screen (additive colors) and other filter colors match the complementary colors of the color components of the screen (subtractive colors).

5. The stereoscopic display method of claim 1, where color filters are arranged in reverse spatial order to the internal order of the color sub-pixels in the screen pixels.

6. The stereoscopic display method of claim 1, used with a head tracking device, where color components used in each screen pixel for the left and right images are shifted in correlation with the head movement, keeping the left image color components visible to the left eye and the right image color components visible to the right eye through the color filters in real-time.

7. The stereoscopic display method of claim 1, used with a head tracking device, where color filters are moved in correlation with the head movement, keeping the left image color components visible to the left eye and the right image color components visible to the right eye through the color filters in real-time.

8. The stereoscopic display method of claim 1, used with a head tracking device, where the left and right images are generated from three-dimensional data in correlation with the head movement, maintaining a realistic three-dimensional image seen from the correct angle and perspective for the left and right eyes in real-time.

9. The stereoscopic display method of claim 1, where the color parallax barrier is positioned at a distance from the screen that allows multiple viewers to see the stereoscopic image from different positions, so each screen pixel is seen by different viewers through a different cycle of color filters.

10. The stereoscopic display method of claim 1, where the color parallax barrier has a lenticular shape.

11. The stereoscopic display method of claim 1, where the color filters of the color parallax barrier are arranged in a diagonal or delta pattern, so the screen color components seen through the filters are shifted horizontally along the vertical axis.

12. Switchable stereoscopic display method using a parallax barrier made of transparent material with closed channels, filling the channels with ink to activate the barrier for three-dimensional viewing, and emptying the channels to deactivate the barrier for two-dimensional viewing.

13. The switchable stereoscopic display method of claim 12, where the ink channels are arranged in layers, and having the width of the channels wider than the gap between the channels, creating a partial overlap between the edges of ink channels in different layers.

14. Switchable color parallax barrier for stereoscopic display using bands of color polarizing elements to change the polarization of light of selected wavelengths, and using a polarizing filter to block selected wavelengths of polarized light, creating interleaved bands of color filters for three-dimensional viewing and allowing the color filters to be switched off for two-dimensional viewing.

15. The switchable color parallax barrier of claim 14, where wavelength dependent light polarizers are used to polarize selected wavelengths of light.

16. The switchable color parallax barrier of claim 14, where wavelength dependent wave retarders are used to change the polarization of selected wavelengths of already polarized light.

17. The switchable color parallax barrier of claim 14, where a polarizing filter is used to polarize all light prior to changing the polarization of selected wavelengths of light by wavelength dependent wave retarders.

18. The switchable color parallax barrier of claim 14, where a liquid crystal polarizing filter is switched on electronically to transmit only light of selected polarization, and switched off to transmit all light.

19. The switchable color parallax barrier of claim 14, where layers of bands of wavelength dependent wave retarders are phase-shifted to switch the wavelength dependent polarization on or off.

20. The switchable color parallax barrier of claim 14, where layers of spaced apart bands of wavelength dependent wave retarders are phase-shifted to switch the wavelength dependent polarization on or off.
